(19) United States
(12) Patent Application Publication
(10) Pub. No.: US 2008/0314900 A1
(43) Pub. Date: Dec. 25, 2008

(54) ENCLOSURE HAVING AN AUTOMATIC IDENTIFICATION DEVICE

(75) Inventors: Frederick Biesecker, Boyertown, PA (US); Gregory Sprishen, Newtown Square, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Drug Plastics & Glass Company, Inc., Boyertown, PA (US)

(21) Appl. No.: 12/139,889

(22) Filed: Jun. 16, 2008

Related U.S. Application Data
(60) Provisional application No. 60/944,003, filed on Jun. 14, 2007.

(51) Int. Cl. B65D 51/00; G06K 19/06

(52) U.S. Cl. 220/212; 235/492

(57) ABSTRACT

An enclosure for enclosing an automatic identification device includes an outer cap that has a base wall and a skirt depending therefrom and an inner cap that has a base wall and a skirt depending therefrom. The inner cap is removably secured within the outer cap. A gap is located between the base wall of the outer cap and the base wall of the inner cap when the inner cap is secured within the outer cap. An automatic identification device is located within the gap and preferably secured to an interior surface of one of the base wall of the outer cap and the base wall of the inner cap. The gap is sized and shaped to receive the automatic identification device.

### CROSS-REFERENCE TO RELATED APPLICATIONS

The present application claims the benefit of U.S. Provisional Patent Application No. 60/944,003, filed Jun. 14, 2007 and entitled “Automatic Identification Device Assembly”, the entire subject matter of which is hereby incorporated by reference.

### BACKGROUND OF THE INVENTION

The present invention relates to the incorporation of an automatic identification device within a package or container for quickly and efficiently identifying the contents of the packaging or container. More specifically, the present invention relates to an enclosure for enclosing an automatic identification device and a container for enclosing an automatic identification device for identifying the contents therein.

Pharmaceutical or medical containers for storing, transporting or selling pharmaceutical or medical products are generally well-known. Such containers, bottles or packages are preferably formed of a high strength, lightweight material and are sized and shaped to be easily transported either individually or in a larger container. Such containers typically include a removable cap. Generally, the caps are removed from the container by a twisting motion. Further, certain containers include child-resistant caps that require a specific twisting function to remove the cap from the top of the container.

The process of preparing containers of medicaments for shipment to an end user typically includes steps of: (1) filling the container with a medicament, (2) sealing the end of the container with the cap, and (3) paper labeling the container with the contents of the container and other information related to the manufacturing history.

Such containers are typically included in a larger package to transport the containers and are then individually placed on a shelf in a retail store for selling the product. Although the containers can contain a plurality of different types of pharmaceutical or medical products, the general appearance of the containers is often similar. Due to the similarity, it may be difficult to identify the contents of the container without opening the container to find out what is inside.

It is of the utmost importance that the information on the paper labeling of each container corresponds exactly to the actual contents of the container and includes such information that allows for traceability to the history of manufacture. Thus, information should ideally be associated with each filled container from near the moment that the container is filled.

Presently, however, it is not possible to include with each vial or container at the time of filling, all of the required information on the container contents and manufacturing, since paper labeling applied to the container at the time of filling does not always survive the manufacturing and shipping process, and there is sometimes insufficient room on the label to include all of the required information. Further, the destination for each filled container is usually not known at the time the container is filled. Since the minimum information to be applied to a paper label is generally prescribed by law, and such laws vary from country to country, the paper labeling of containers can not be done until the destination of a particular lot of containers is determined. Such determination may not be made until after a specific lot of the filled containers has been shelved for a period of time. In order to establish traceability of the containers in a lot that has been shelved, back to the time that the containers were filled, samples from each lot must be taken from the shelved lot prior to paper labeling, and the contents of the samples determined analytically. Such a procedure is time consuming and expensive.

A further problem associated with labeling of the containers is one of counterfeiting. Counterfeiting may utilize packaging and paper labeling identical to the legitimate articles such that even an experienced end user pharmacist or medical practitioner can not distinguish the counterfeit article from the legitimate article.

Automatic identification technology, which increases business efficiency, reduces data-entry errors and frees-up staff to perform other functions, is generally well-known. Automatic identification is a broad term given to a host of technologies that are used to help machines identify objects. The technologies include bar codes, smart cards, voice recognition, biometric technology, optical character recognition and radio frequency identification (RFID). Specifically, RFID technology uses radio waves to automatically identify objects. By storing product information on a microchip that is attached to an antenna, RFID circuits or tags allow a reader to easily and efficiently identify an object and allow for the addition or deletion of information at any time.

Various prior art devices have incorporated RFID tags within pharmaceutical containers to avoid the problems described above. Previously, individuals have attempted to mold RFID tags within the containers. However, problem arises when a manufacturer, seller or user attempts to mold the RFID tag into the plastic container because the high temperatures achieved during the molding process damage or destroy the RFID tag.

Therefore, it would be desirable to add an automatic identification device to the caps of pharmaceutical or medical packages or containers such that a user or manufacturer can quickly and efficiently identify the contents of a packages or container without inspecting the contents of each package or container. Specifically, it would be desirable to include an RFID tag within a cap of a pharmaceutical or medical package or container without having to mold the RFID tag to the cap such that a user could quickly scan the container and accurately identify the product within the container. This combination would allow for an accurate knowledge of the inventory level by eliminating the discrepancy between inventory record and physical inventory and also prevent destruction of the RFID tag. Further, the sources of error of recordation can be prevented or reduced.

### SUMMARY OF THE INVENTION

Briefly stated, a preferred embodiment of the present invention is directed to an enclosure for enclosing an automatic identification device, the enclosure including an outer cap having a base wall and a skirt depending therefrom and an inner cap having a base wall and a skirt depending therefrom. The inner cap is removably secured within the outer cap. A gap is located between the base wall of the outer cap and the base wall of the inner cap when the inner cap is secured within the outer cap. An automatic identification device is located within the gap and is preferably secured to an interior surface of one of the base wall of the outer cap and the base wall of the inner cap. The gap is sized and shaped to receive the automatic identification device.

In another aspect, a preferred embodiment of the present invention is directed to a container enclosing an automatic identification device for identifying the contents therein. The container includes a bottom having an outer periphery, a neck defining an opening at a top portion thereof for receiving a product and a shoulder proximate a bottom portion thereof, and a sidewall extending generally upwardly from the periphery of the bottom to the shoulder of the neck. A closure is removably engagable to the neck. The closure has an outer cap removably securable to an inner cap. An automatic identification device is mounted between the outer and inner caps of the closure.

### BRIEF DESCRIPTION OF THE SEVERAL VIEWS OF THE DRAWINGS

The following detailed description of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a top perspective view of a preferred embodiment of an enclosure in accordance with the present invention;

FIG. 2 is a bottom perspective view of the enclosure shown in FIG. 1;

FIG. 3 is a side elevation view of the enclosure shown in FIG. 1;

FIG. 3A is a cross-sectional view of the enclosure shown in FIG. 3, taken along line A-A of FIG. 3;

FIG. 3B is a greatly enlarged fragmentary view of a portion of the enclosure taken along circle “B” in FIG. 3A;

FIG. 4 is a bottom perspective view of the enclosure with an inner cap removed for clarity;

FIG. 5 is a bottom plan view of the enclosure with the inner cap removed for clarity;

FIG. 6 is a top perspective view of a preferred embodiment of a container in accordance with the present invention; and

FIG. 7 is a top perspective view of the container shown in FIG. 6 with the enclosure removed for clarity.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of an enclosure or container in accordance with the present invention, and designated parts thereof. The terminology includes the words noted above, derivatives thereof and words of similar import.

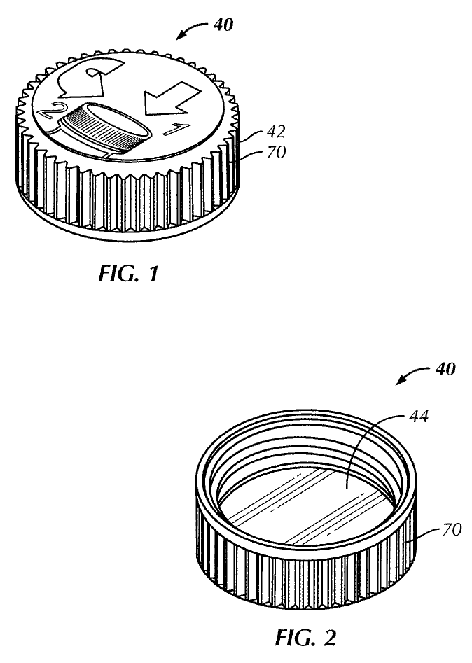

FIGS. 1-7 depict an enclosure, or cap, generally designated 40, for enclosing an automatic identification device 62 and/or a container or bottle 10 used to store, transport or sell various products, such as a pharmaceutical or medical products such that a manufacturer, distributor or consumer can quickly and easily identify the contents of the container 10. The enclosure or cap 40 is generally described in U.S. Pat. No. 6,206,216 (the '216 patent), which is hereby incorporated by reference in its entirety. It is understood by those skilled in the art that the container 10 can be of virtually any form or shape, such as a vial, vase or any other container capable of holding pharmaceutical, medical or other products, without departing from the spirit and scope of the invention.

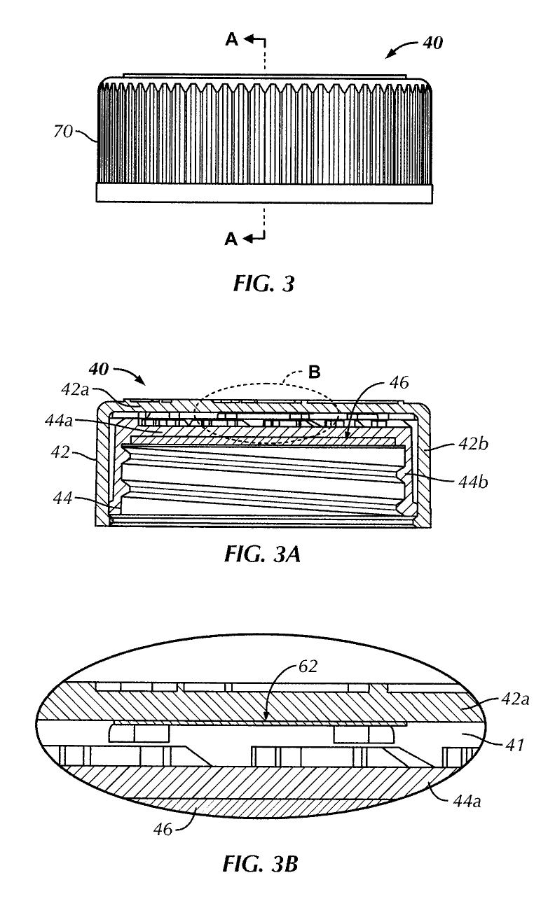

The cap 40 comprises an outer cap 42 respectively secured to an inner cap 44. The outer and inner caps 42, 44 each have a base wall 42a, 44a, respectively, and a skirt 42b, 44b, respectively, depending therefrom. The outer cap 42 preferably includes gripping ridges 70 on an exterior surface and may include instructions (FIG. 1) for how to remove the cap 40 from the container 10. When the outer cap 42 is secured to the inner cap 44, a gap 41 exists between the base walls 42a, 44a that allows for the inclusion of the automatic identification device 62 therein (FIGS. 3A and 3B). The gap 41 is sized and shaped to receive the automatic identification device 62. The inner cap 44 may include a liner 46 to properly seal the cap 40 to the container 10.

It is understood by those skilled in the art that the present invention does not require all of the particulars of the cap 40 as described above. For example, it is within the spirit and scope of the invention that the cap 40 can be in the form of virtually any double shell cap. Further, it is understood that the cap 40 can be virtually any size and shape that can properly enclose the outer container 10 and securely attach to the neck portion 22. The cap 40 is preferably formed of a polymeric material, but it is understood by those skilled in the art that the cap 40 may be formed of virtually any high-strength, lightweight material, such as a metallic material, without departing from the spirit and the scope of the invention.

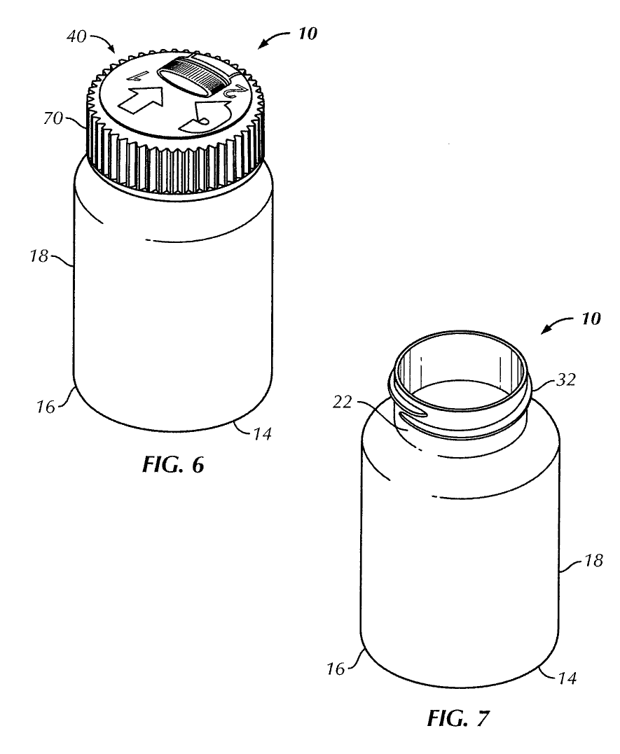

FIGS. 6 and 7 depict a preferred embodiment of the container 10, which is used for storing, transporting or selling a product, such as a pharmaceutical or medical product. The container 10 comprises a container bottom 14 having an outer periphery 16 and a container wall or sidewall 18 extending generally upward from the periphery 16. It is preferred that the container bottom 14 be generally planar, although the bottom 14 may be concave.

The periphery 16 of the container bottom 14 may be slightly rounded to eliminate any sharpe edges from the container 10. Preferably, the container bottom 14 and the sidewall 18 define container 10 which is generally annular in cross-section, although the container 10 may be of any shape, such as a generally rectangular in cross-section, as one of ordinary skill in the art would understand. Further, it is understood by those skilled in the art that the form and shape of the container 10 can be modified without departing from the spirit and scope of the invention. For example, the container 10 can be in the form of virtually any shape, such as a vial, vase or any other such packaging or container, without departing from the spirit and the scope of the invention. The container 10 is preferably formed of a polymeric material, but it is understood by those skilled in the art that the container 10 may be formed of virtually any high-strength, lightweight material, such as a metallic material or glass, without departing from the spirit and the scope of the invention.

As shown in 6 and 7, the container wall 18 comprises a neck 22 at a top portion thereof defining an opening for receiving the product. Preferably, the opening in the neck 22 is generally circular in cross-section and has an inner diameter which is smaller than the inner diameter of the container wall 18. The neck 22 includes a transition surface, or shoulder 25, between the neck 22 and the sidewall 18 and proximate a bottom portion of the neck 22. The shoulder 25 is preferably curved to eliminate any sharp edges and increase structural integrity. The neck 22 preferably includes threads 32 for receiving the enclosure 40.

In reference to FIGS. 3A-5, the automatic identification device 62, such as an RFID tag or transponder, is shown. RFID tags 62 are generally well known in the art as a method of identification by storing and remotely retrieving data. In the preferred embodiment, the RFID tag 60 contains a silicon chip 62a and an antenna 62b operatively connected with other components to form a circuit. However, it is understood by those skilled in the art that any form of automatic identification can be used in the present invention without departing from the spirit and scope of the invention.

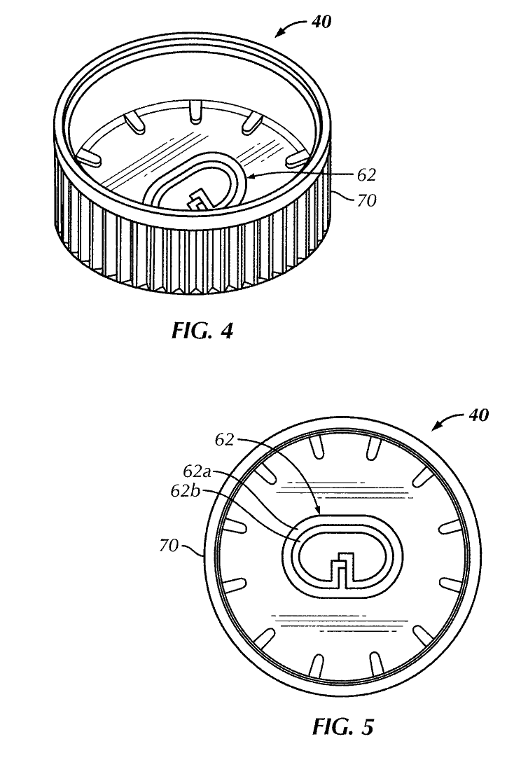

As shown in FIG. 4, in the preferred embodiment, the RFID tag 62 is adhesively attached to one of the interior of the outer cap 42 and the exterior of the inner cap 44. However, it is understood by those skilled in the art that virtually any method of securing the automatic identification device 62 may be employed, such as by friction-fit, rivet(s) or bolt(s), for example. For example, during assembly of the present invention, a manufacturer, distributor or consumer would place the RFID tag 62 against the interior of the outer cap 42 using an adhesive. Although the RFID tag 62 is adhesively attached to the outer cap 42 in the preferred embodiment, it is understood by those skilled in the art that any other means of attaching the RFID tag 62 to the cap 40 is within the spirit and scope of the invention. For example, the RFID tag 62 may frictionally engage the outer cap 44 or may be attached to the outer cap 44 by some form of fastener. Further, it is within the spirit and scope of the invention that the RFID tag 62, or any other form of automatic identification device, can be adhesively, frictionally, or by means of a fastener, secured to any portion of the cap 40. Once the RFID tag 62 is properly mounted to the interior of the outer cap 42, the inner cap 44 is placed inside the outer cap 42, thus enclosing the RFID tag 62 between the inner and outer caps 44, 42. Specifically, the RFID tag 62 is located within the gap 41. This location provides protection to the RFID tag 62 and assures that the manufacturer, distributor or consumer knows the exact location of the RFID tag 62. As an alternative, the RFID tag 62 may be placed within the gap 41 without being secured to either the inner or outer caps 44, 42.

In operation, a manufacturer, distributor or consumer places a desired amount of the product into the container 10. An automatic identification device, such as the RFID tag 62, may then be placed in the interior of the outer cap 42. Next, the inner cap 44 is attached to the outer cap 44 to enclose the RFID tag 62 within the gap 41. Alternatively, RFID tag 62 may be placed between the inner and outer caps 44, 42 without being attached to either the inner or outer caps 44, 42. The manufacturer, distributor or consumer then securely fastens the enclosure 40 to the container 10. The container 10 is then ready for shipment or for sale. When the manufacturer, distributor or consumer desires to know the contents of the container 10, a scanner (not shown) is placed within the general vicinity of the container to read the information stored in the RFID tag 62. The RFID tag 62 is generally well protected when securely located within the cap 40, as taught by the present invention. A user or manufacturer will also generally know the exact location of the RFID tag 62 when attempting to identify the contents of the container.

It will be appreciated by those skilled in the art that changes could be made to the embodiments described above without departing from the broad inventive concept thereof. It is understood, therefore, that this invention is not limited to the particular embodiment disclosed but it is intended to cover modifications within the spirit and scope of the present invention as defined by the drawings and specification.

I/We claim:

1. An enclosure having an automatic identification device, said enclosure comprising:
an outer cap having a base wall and a skirt depending therefrom:
an inner cap having a base wall and a skirt depending therefrom, said inner cap being removably secured within said outer cap;
a gap located between said base wall of said outer cap and said base wall of said inner cap when said inner cap is secured within said outer cap; and
an automatic identification device located within said gap;
wherein said gap is sized and shaped to receive said automatic identification device.

2. The enclosure according to claim 1, wherein said automatic identification device is comprised of an RFID transponder having a silicon chip operatively engaged to an antenna.

3. The enclosure according to claim 1, wherein said automatic identification device is secured to an interior surface of one of said base wall of said outer cap and said base wall of said inner cap

4. The enclosure according to claim 3, wherein said automatic identification device is secured to one of said outer cap and said inner cap by adhesive.

5. A container enclosing an automatic identification device for identifying the contents therein, said container comprising:
a bottom having an outer periphery:
a neck defining an opening at a top portion thereof for receiving a product and a shoulder proximate a bottom portion thereof;
a sidewall extending generally upwardly from said periphery of said bottom to said shoulder of said neck;
a enclosure removably engageable to said neck, said closure having an outer cap removably securable to an inner cap; and
an automatic identification device mounted between said outer and inner caps of said enclosure.

6. The container according to claim 5, wherein said automatic identification device is comprised of an RFID transponder having a chip operatively engaged to an antenna.

7. The container according to claim 5, wherein said an outer cap includes a base wall and a skirt depending therefrom, said an inner cap includes a base wall and a skirt depending therefrom and wherein a gap exists between said base wall of said outer cap and said base wall of said inner cap when said inner cap is secured within said outer cap, said gap being sized and shaped to receive said automatic identification device.

8. The container according to claim 7, wherein said automatic identification device is adhesively secured to an interior surface of said base wall of said outer cap.
